(19) United States
(12) Patent Application Publication
(10) Pub. No.: US 2003/0145191 A1
(43) Pub. Date: Jul. 31, 2003

(54) Computer system and method of controlling the same

(75) Inventor: Jong-hyun Park, Seoul-city (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD.

(21) Appl. No.: 10/238,723

(22) Filed: Sep. 11, 2002

(30) Foreign Application Priority Data
Jan. 25, 2002 (KR) 2002-4500

(51) Int. Cl. G06F 15/177

(52) U.S. Cl. 713/1; 713/320

(57) ABSTRACT

A method of controlling a computer system comprising backing up of a user's last system environment of the computer system in a flash memory when the computer system is turned off; determining whether the flash memory is connected to the computer system when the computer system is booted; and restoring the computer system on basis of the user's system environment stored in the flash memory when the flash memory is connected to the computer system. The present invention provides a computer system and a method of controlling the same, in which a system environment that a user desires can be applied to any other computer system, and a user's last application operation environment can be directly executed.

### CROSS-REFERENCE TO RELATED APPLICATIONS

This application claims the benefit of Korean Application No. 2002-4500 filed Jan. 25, 2002, in the Korean Intellectual Property Office, the disclosure of which is incorporated herein by reference.

### BACKGROUND OF THE INVENTION

1. Field of the Invention

The present invention relates to a computer system and a method of controlling the same, in which a system environment and a user's last operation environment are stored in a flash memory, so that the system environment that a user desires can be applied to any other computer systems, and the user's last operation environment can be directly executed.

2. Description of the Related Art

Because of widespread use of a computer system at home, in a school, in an office, etc., a user can have many opportunities to use another computer system as necessary.

However, because a system environment of a typical computer system depends on an individual preference, another computer system may be unfamiliar and inconvenient to the user. Thus, a user ought to adapt the system environment of the other computer system for the user.

Further, because an operation result by the typical computer system is stored in a hard disk fastened to/integrated with the computer system, the system environment is not portable.

Moreover, to open a file of an application program by using a newly booted computer system or other computer system, a user must execute the application program again from the beginning.

On the other hand, a flash memory which is a nonvolatile memory can retain its data even if power is turned off, and is often used in portable devices. Some memories such as the hard disk include a head and a head driving part which enables the head to read data from and write data to the memory, but the flash memory does not include the head and the head driving part, so that the flash memory can be made small and is resistant to impact. Therefore, the flash memory is handy to carry. Further, a recently developed flash memory has a relatively large storage capacity and can store a large amount of data therein.

### SUMMARY OF THE INVENTION

Accordingly, an object of the present invention is to provide a computer system and a method of controlling the same, in which a system environment that a user desires can be applied to any other computer system, and the user's last application operation environment can be directly executed.

Additional objects and advantages of the invention will be set forth in part in the description which follows and, in part, will be obvious from the description, or may be learned by practice of the invention.

The foregoing and other objects of the present invention are achieved by providing a method of controlling a computer system, comprising backing up a user's last system environment of the computer system in a flash memory when the computer system is turned off; determining whether the flash memory is connected to the computer system when the computer system is booted; and restoring the computer system on the basis of the user's last system environment stored in the flash memory when the flash memory is connected to the computer system. Further, the flash memory is a detachable flash memory, allowing the user to apply the user's last system environment at any computer system and to further directly execute a last application program.

According to an aspect of the invention, the method further comprises backing up the user's system environment in the flash memory when the computer system goes into a power saving mode.

According to an aspect of the invention, the user's last system environment includes at least one of a BIOS environment and an OS environment which is set by a user.

According to another aspect of the present invention, the foregoing and other objects may be achieved by providing a computer system comprising a flash memory in communication with the computer system; and a control part storing a user's last system environment of the computer system in the flash memory when the computer system is turned off, determining whether the flash memory is connected to the computer system when the computer system is booted, and restoring the computer system on basis of the user's last system environment stored in the flash memory when the flash memory is connected to the computer system.

### BRIEF DESCRIPTION OF THE DRAWINGS

These and other objects and advantages of the present invention will become apparent and more readily appreciated from the following description of the example embodiments, taken in conjunction with the accompany drawings of which:

FIG. 1 is a control block diagram of a computer system according to an embodiment of the present invention;

FIG. 2 illustrates an example system environment data stored in a memory of the computer system according to an embodiment of the present invention;

FIG. 3 is a flowchart of processes when the computer system according to the present invention comes goes into a power saving mode; and

FIG. 4 is a flowchart of a process when the computer system according to the present invention is booted.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

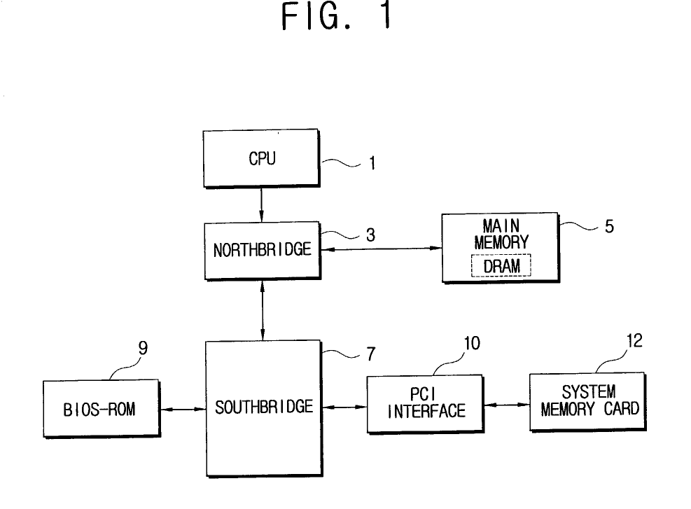

FIG. 1 is a control block diagram of a computer system according to an embodiment of the present invention. As shown therein, the computer system can comprise a CPU (central processing unit) 1, a main memory 5 which can be a DRAM (dynamic random access memory), a BIOS-ROM (basic input/output system-read only memory) 9 having information on a BIOS, a northbridge 3, a southbridge 7, a PCI (peripheral component interconnect) interface 10, and a system memory card 12 to be connected to the computer system through the PCI interface 10.

The northbridge 3 is a chipset performing data transmission among the CPU 1, the main memory 5, a graphic card (not shown), etc. The southbridge 7 is a chipset performing data transmission among any other components (not shown) except the components whose data transmission is performed by the northbridge 3. That is, the southbridge 7 can perform data transmission among a keyboard/mouse (not shown), a USB (universal serial bus) port (not shown), a PCI bus, etc.

Typically, the BIOS stored in the BIOS-ROM 9 is a program setting up various information (e.g., configurations) on devices/components of the computer system, and typically a user can set up the information through a BIOS setup menu. Typically, the BIOS performs a POST (power on self test) to test whether devices/components in the computer system are normal or abnormal.

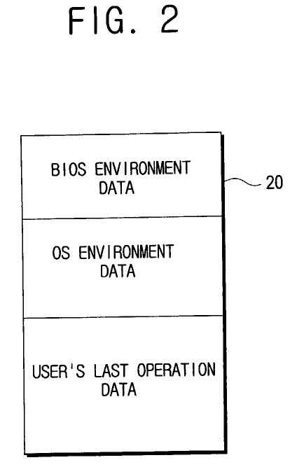

The system memory card 12 according to an aspect of the present invention is employed as a portable flash memory rewritably storing data and detachably attached to the PCI interface 10, and can store information on a BIOS environment, an OS (operating system) environment, and/or a user's last application operation environment, which are typically stored in a memory, such as main memory 5 of the computer system (refer to FIG. 2) and collectively referred to as a system environment 20. The system memory card 12 is connected to the computer system through the PCI interface 10, and stores data from and provides data to the computer system. Although in the example embodiment, a detachable non-volatile storage is embodied in the portable flash memory 12, the present invention is not limited to such configuration and the detachable non-volatile storage can be any detachable non-volatile storage, such as, without limitation, detachable recording media.

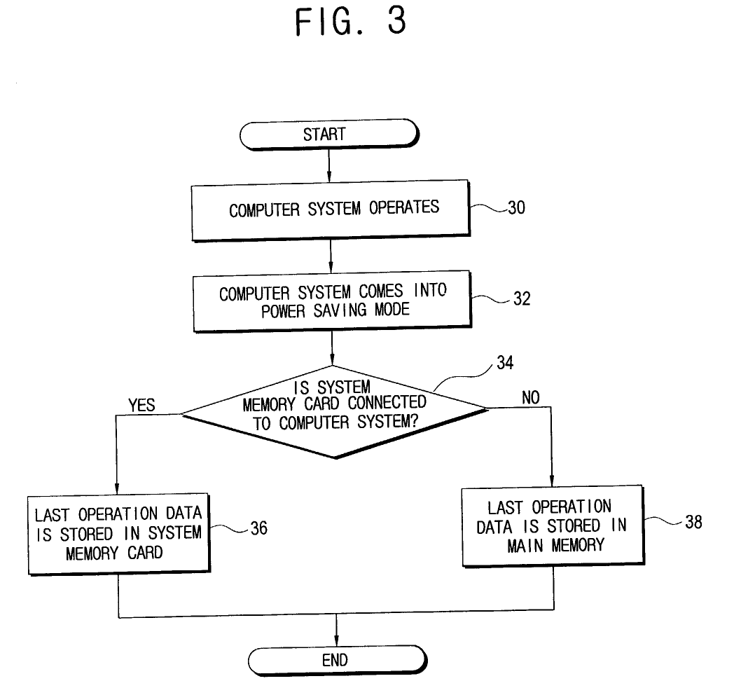

With reference to FIG. 3, an example process of backing up data in the system memory card 12 of the computer system is described.

As illustrated in FIG. 3, at operation 30 while a user operates the computer system, if the computer system does not receive any input from a user for a predetermined period of time, at operation 32 the computer system goes into a power saving mode. Typically, in the power saving mode, the user's last operation data (i.e., last application operation) of the computer system is stored in the main memory 5 and the whole computer system is turned off except for the main memory 5 to restore the user's last application operation environment of the computer system when the computer system is awakened from the power saving mode.

At operation 34, the computer system determines whether the system memory card 12 is connected to the computer system. At operation 38, when the system memory card 12 is not connected to the computer system, last operation data is stored in the main memory 5. Oppositely, at operation 36 when the system memory card 12 is connected to the computer system, last operation data is stored in the system memory card 12.

Further, in an aspect of the invention, the foregoing process in FIG. 3 is applied in a case where a user turns off the computer system, that is, in operation 32 in FIG. 3, the computer system is selected to be turned off instead of going into the power saving mode.

Thus, when a user turns off the computer system with the system memory card 12, last operation data is stored to the system memory card 12.

In an aspect of the invention, at the operation 36, the BIOS environment and the OS environment which a user uses and typically can be configured via a BIOS setup menu, can also be stored in the system memory card 12. The system memory card 12 storing the last operation data, the BIOS environment and/or the OS environment (i.e., storing system environment 20) can be detached from the PCI interface 10, namely, a PCI slot, and carried by a user. Therefore, when a user uses another computer system, the system memory card 12 can be attached to the PCI slot of the other computer system, thereby allowing the other computer system to boot with the user's system environment.

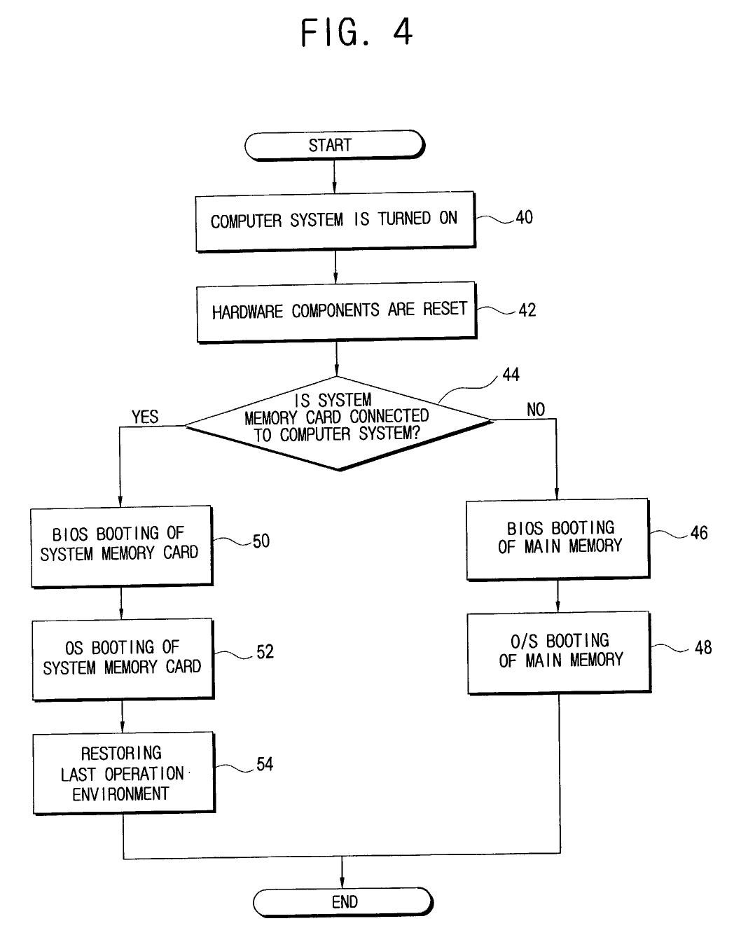

With reference to FIG. 4, to give a better understanding of the present invention, an example booting process of the example computer system will be described. In particular, an example process of reading data from the system memory card 12 by the computer system will be described. First, at operation 40 the computer is turned on and at operation 42 the southbridge 7, the northbridge 3 and the CPU 1 are sequentially reset in response to a reset signal generated when power is supplied.

At operation 44, the CPU 1 determines whether the system memory card 12 is connected to the computer system.

At operation 46, when the system memory card 12 is not connected to the computer system, the CPU 1 executes the BIOS stored in the BIOS-ROM 9 so as to perform the POST, resetting the devices of the computer system, i.e., perform the BIOS booting.

At operation 48, after the BIOS booting, the BIOS loads the OS onto the main memory 5, to thereby perform the OS booting. At operation 48, according to the OS booting, the computer system is booted with the OS beginning screen.

At operation 50, when the system memory card 12 is connected to the computer system, the CPU 1 executes the BIOS stored in the system memory card 12 to perform a BIOS booting with the data stored on the memory card 12. Therefore, a user can use another computer system with the user's BIOS environment (i.e., a BIOS environment that a user desires). At operation 52, after the BIOS booting, the BIOS reads the OS onto the main memory 5 from the integrated hard disk (not shown) of the computer system, and performs OS booting on basis of OS environment stored in the system memory card 12. Therefore, a user can use the other computer system with the user's OS environment (i.e., an OS environment that a user desires).

At operation 54, according to the OS booting, a screen (typically a display screen of an application program) of the computer system can be restored on the basis of the last application operation stored in the system memory card 12. Therefore, a user can use another computer system with the user's last application operation environment being directly executed.

Processes of the invention as a boot controller can be embodied in software and/or hardware, for example, as part of northbridge 3, southbridge 7, and executing on the computer system, using known techniques. According to the present invention, when the system memory card 12 is connected to the computer system, the devices of the computer system are not reset by the BIOS stored in the BIOS-ROM 9, but by the BIOS stored in the system memory card 12. Further, the BIOS loads the OS onto the main memory 5, performs the OS booting on the basis of the OS environment stored in the system memory card 12, and restores a screen on the basis of the user's last application operation environment stored in the system memory card 12. Thus, the computer system can be booted with a last application operation screen on another computer.

In the above example description, the system memory card 12 is attached to the PCI interface 10. However, the system memory card 12 may be attached to a USB interface, a PCMCIA (personal computer memory card international association) interface for a portable computer, ISA (industry standard architecture) interface, or etc.

As described above, according to the present invention, information on a BIOS environment, an OS (operating system) environment, and/or a user's last application operation environment are stored in a portable flash memory rewritably storing data and detachably attached to a PCI interface, and a computer system is booted on the basis of the data stored in the flash memory, thereby allowing a user to use any other computer systems under the same user's system environment, and further, to directly execute the last application operation environment.

As described above, the present invention provides a computer system and a method of controlling the same, in which a system environment that a user desires can be applied to any other computer systems, and further a user's last application operation environment can be directly executed.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of controlling a computer system, comprising:
backing up a user's last system environment of the computer system in a flash memory when the computer system is turned off;
determining whether the flash memory is connected to the computer system when the computer system is booted; and
restoring the computer system on based upon the user's last system environment stored in the flash memory when the flash memory is connected to the computer system.

2. The method according to claim 1, further comprising backing up the user's system environment in the flash memory when the computer system goes into a power saving mode.

3. The method according to claim 1, wherein the user's last system environment includes at least one of a BIOS environment and an OS environment set by the user.

4. The method according to claim 2, wherein the user's last system environment includes at least one of a BIOS environment and an OS environment which is set by a user.

5. A computer system comprising:
a detachable flash memory; and
a boot controller storing a user's last system environment of the computer system in the flash memory when the computer system is turned off, determining whether the flash memory is connected to the computer system when the computer system is booted, and restoring the computer system on based upon the user's last system environment stored in the flash memory when the flash memory is connected to the computer system.

6. The computer system according to claim 5, wherein the controller backs up the user's last system environment in the flash memory when the computer system goes into a power saving mode.

7. The computer system according to claim 5, wherein the user's last system environment includes at least one of a BIOS environment and an OS environment set by the user.

8. The computer system according to claim 6, wherein the user's last system environment includes at least one of a BIOS environment and an OS environment set by the user.

9. A computer readable storage controlling a computer by a process, comprising:
backing up a user's system environment of the computer in a flash memory connected to the computer when the computer is turned off and/or when the computer goes into a power saving mode;
determining whether the flash memory is connected to the computer when the computer system is booted; and
restoring the computer based upon the user's system environment stored in the flash memory when the flash memory is connected to the computer.

10. The computer readable storage of claim 9, wherein the user's last system environment comprises at least one of a BIOS environment, an OS environment, and the user's last application operation environment.

11. The computer readable storage of claim 10, wherein restoration of the computer comprises restoring a display screen of an application program based upon the user's last application operation environment, thereby allowing the user to directly execute the user's last application program.
